(19) United States
(12) Patent Application Publication
(10) Pub. No.: US 2007/0177117 A1
(43) Pub. Date: Aug. 2, 2007

(54) EXPOSURE APPARATUS AND DEVICE MANUFACTURING METHOD

(76) Inventor: Keiji Yamashita, Utsunomiya-shi (JP)

Correspondence Address: MORGAN & FINNEGAN, L.L.P., 3 WORLD FINANCIAL CENTER, NEW YORK, NY, 10281-2101, US

(21) Appl. No.: 11/625,376

(22) Filed: Jan. 22, 2007

(30) Foreign Application Priority Data
Jan. 27, 2006 (JP) 2006-019134

(51) Int. Cl. G03B 27/42

(52) U.S. Cl. 355/53; 355/30

(57) ABSTRACT

An exposure apparatus for exposing a substrate via liquid includes a supply nozzle configured to supply the liquid, and a recovery nozzle configured to recover the liquid, wherein at least one of the supply nozzle and the recovery nozzle includes porous ceramic with an oxide film.

### BACKGROUND OF THE INVENTION

The present invention relates to an exposure apparatus.

A conventional reduction projection exposure apparatus projects a circuit pattern of a reticle (mask) onto a wafer or another substrate via a projection optical system in manufacturing fine devices, such as a semiconductor memory and a logic circuit, using the photolithography technology.

The minimum critical dimension (resolution) transferable by the reduction projection exposure apparatus is proportionate to a wavelength of the light used for exposure, and inversely proportionate to the numerical aperture (“NA”) of the projection optical system. The shorter the wavelength is and the higher the NA is, the smaller the resolution is. Along with the recent demand for the fine processing to a semiconductor device, use of a shorter wavelength of the exposure light is promoted. For example, use of the ultraviolet light having a shorter wavelength is promoted from a KrF excimer laser (with a wavelength of approximately 248 nm) to an ArF excimer laser (with a wavelength of approximately 193 nm).

With this background, the immersion exposure is one attractive resolution improving technology that uses a light source, such as the ArF excimer laser. The immersion exposure increases an apparent NA of the projection optical system and improves the resolution by filling the liquid in a space between the final lens of the projection optical system and the wafer (or by replacing the medium at the wafer side of the projection optical system with the liquid) and by shortening the effective wavelength of the exposure light. The NA of the projection optical system is defined as NA=n·sin θ, where n is a refractive index of the medium. The NA increases up to n when the medium has a refractive index higher than the air's refractive index, i.e., n>1.

In the immersion exposure, there are proposed two methods for filling the liquid between the final lens of the projection optical system and the wafer. The first method puts the final lens of the projection optical system and the entire wafer under the liquid in a sink. The second method is a local fill method that locally flows the liquid in a space between the projection optical system and the wafer.

The exposure apparatus of the local fill method has a liquid supply unit that supplies the liquid between the final lens of the projection optical system and the wafer via the supply nozzle, and a liquid recovery unit that recovers the supplied liquid via a recovery nozzle. It is proposed to make the supply nozzle and the recovery nozzle of porous ceramic, so as to prevent positional scattering of the liquid supply amount and recovery amount and dripping of the liquid. See, for example, Japanese Patent Application, Publication No. 2005-191344.

In addition, the exposure apparatus of the local fill method arranges around the wafer a liquid holder or liquid holding plate having a surface that is approximately level with the wafer's top surface, so as to prevent the liquid from splitting in exposing wafer's edge shots. Similar to the supply nozzle and the recovery nozzle, it is proposed to use of porous ceramic for part of the liquid holding plate. See, for example, Japanese Patent Application, Publication No. 2005-101487.

However, in the immersion exposure, metal elutes from liquid contacting part, especially a supply nozzle, a recovery nozzle, and a liquid holder, each of which is made of porous ceramic, and porous ceramic itself can be destroyed. In that case, the eluted metal and destroyed porous member float as particles or impurities in the liquid. The particles floating in the liquid adhere to the wafer surface could cause disconnections of the device's wiring structure in forming the pattern, and the floating particles above the wafer surface shield part of the exposure light from the projection optical system, partially lowering the contrast in an imaged pattern.

### SUMMARY OF THE INVENTION

The present invention is directed to a high-performance exposure apparatus that reduces the particles contained in the liquid.

An exposure apparatus according to one aspect of the present invention for exposing a substrate via liquid includes a supply nozzle configured to supply the liquid, and a recovery nozzle configured to recover the liquid, wherein at least one of the supply nozzle and the recovery nozzle includes porous ceramic with an oxide film.

A further object and other characteristics of the present invention will be made clear by the preferred embodiments described below referring to accompanying drawings.

### BRIEF DESCRIPTION OF THE DRAWINGS

FIG. 1 is a schematic sectional view showing a structure of an exposure apparatus according to one aspect of the present invention.

FIG. 2 is a schematic sectional view of heat-treated porous SiC.

FIG. 3 is a schematic sectional view of porous SiC having an oxide film on its surface layer.

FIG. 4 is a schematic sectional view around a final lens of a projection optical system when the exposure apparatus shown in FIG. 1 exposes peripheral or edge areas on a substrate.

FIG. 5 is a flowchart for explaining a fabrication of a device.

FIG. 6 is a flowchart for a wafer process of step 4 shown in FIG. 5.

### DESCRIPTION OF THE EMBODIMENTS

Referring now to the accompanying drawings, a description will be given of an exposure apparatus according to one aspect of the present invention. In each figure, the same reference numeral designates the same element, and a duplicate description thereof will be omitted.

The exposure apparatus 1 is an immersion exposure apparatus that exposes a circuit pattern of a reticle 20 onto a wafer 40 via liquid L that is supplied in a space between the wafer 40 and a final lens of a projection optical system 30, which final lens is closest to the wafer 40 among the optical elements in the projection optical system 30.

The exposure apparatus 1 uses a step-and-scan exposure manner to expose the wafer 40. However, the exposure apparatus 1 can use a step-and-repeat manner.

The exposure apparatus 1 includes an illumination apparatus 10, a reticle stage 25 mounted with the reticle 20, a projection optical system 30, a wafer stage 45 mounted with the wafer 40, a liquid holding plate 50, a liquid supply/recovery mechanism 60, a distance-measuring unit (not shown), and a controller (not shown). The distance-measuring unit measures two-dimensional positions of the reticle stage 25 and the wafer stage 45 on the real-time basis via reference mirrors and laser interferometers. The controller has a CPU and memory, and controls operation of the exposure apparatus 1, in particular, driving of the reticle stage 25 and the wafer stage 45.

The illumination apparatus 10 illuminates the reticle 20, on which a circuit pattern to be transferred is formed, and includes a light source 12 and an illumination optical system 14.

The light source 12 uses the ArF excimer laser with the wavelength of approximately 193 nm, but can use an F₂ laser with a wavelength of approximately 157 nm. The light source 12 that uses a laser preferably includes a beam shaping optical system.

The illumination optical system 14 illuminates the reticle 20 using the light from the light source 12. The illumination optical system 14 includes a condenser optical system, an optical integrator, an aperture stop, a condenser lens, a masking blade, and an imaging lens.

The reticle 20 is made, for example, of quartz, forms a circuit pattern to be transferred, and is supported and driven by the reticle stage 25.

The reticle stage 25 supports the reticle 20, and is connected to a moving mechanism (not shown).

The projection optical system 30 projects the pattern of the reticle 20 onto the wafer 40. The projection optical system 30 can use a dioptric, catadioptric, or catoptric optical system.

The projection optical system 30 of this embodiment uses a planoconvex lens for a final lens 32 that is closest to the wafer 40. The final lens may use a meniscus lens instead of the planoconvex lens.

A photoresist is applied to the surface of the wafer 40. This embodiment uses a wafer for the substrate, but the substrate may use for a substrate a glass plate and another substrate.

The wafer stage 45 supports the wafer 40 via a wafer chuck (not shown), and is connected to the moving mechanism.

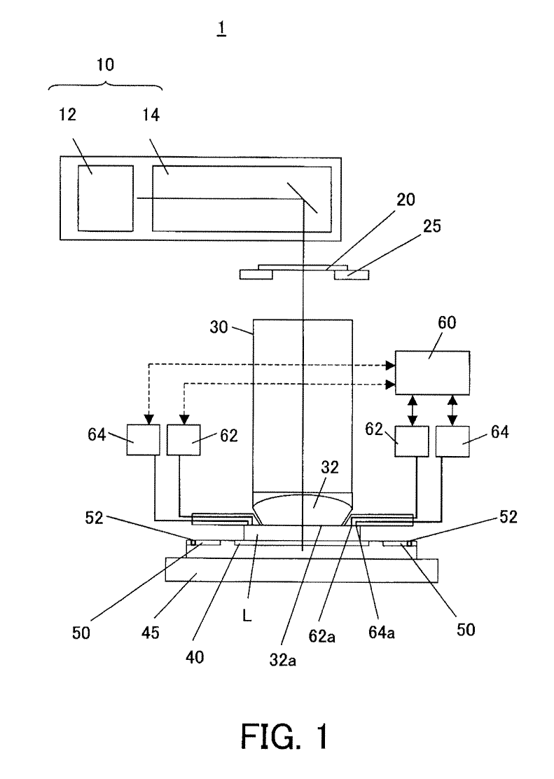

The wafer stage 45 is provided with a liquid holder or liquid holding plate 50 around the wafer 40. The liquid holding plate 50 has a surface level with the surface of the wafer 40, and holds the liquid L, as shown in FIG. 1. When the exposure ends, the extra liquid L that extends out of the exposure area moves to the liquid holding plate 50 outside the wafer 40. The liquid holding plate 50 has a recovery port 52 for the liquid L, which sucks the liquid L from the bottom surface of the liquid holding plate 50, and recovers the moving liquid L. In other words, the recovery port 52 constitutes the liquid passing part or passage of the liquid L.

The liquid supply/recovery mechanism 60 supplies the liquid L to the space between the projection optical system 30 and the wafer 40, and collects the liquid L from the space. The liquid supply/recovery mechanism 60 locally fills the liquid in the space between the projection optical system 30 and the wafer 40, and forms an air curtain (not shown).

The liquid supply/recovery mechanism 60 of this embodiment obtains positional information of the wafer 45, and controls, based on the information, switching and stopping of supply and recovery of the liquid L, and a supply amount and a recovery amount of the liquid L. The liquid supply/recovery mechanism 60 has a liquid supply unit 62, and a liquid recovery unit 64.

The liquid L has a good transmittance to the exposure wavelength, and a refractive index approximately similar to that of a glass material (as a material of the optical element), such as quartz and calcium fluoride. It is necessary to select a material for the liquid L which does not contaminate the projection optical system 30, and matches the resist process. The liquid L is, for example, ultra-pure water, pure water, functional water, fluoride liquid, etc., and a proper material is selected in accordance with the applied resist and the wavelength of the exposure light.

It is necessary to sufficiently remove the residue gas from the liquid L using a deaerator (not shown) in advance. Thereby, the gas generation is restrained, and the gas, even if generated, can be instantly absorbed in the liquid. The exposure apparatus 1 may have the deaerator (not shown) to supply the liquid L while always removing the residue gas from the liquid. A vacuum deaerator is preferable to the deaerator.

The liquid supply unit 62 has the supply nozzle 62a, and supplies the liquid L to the space between the projection optical system 30 and the wafer 40 via the supply nozzle 62a. The liquid supply unit 62 has a tank that stores the liquid L, a compressor that feeds out the liquid L, and a temperature control mechanism that controls the temperature of the supplied liquid L.

The liquid recovery unit 64 has the supply nozzle 64a, and collects the liquid L from the space between the projection optical system 30 and the wafer 40 via the recovery nozzle 64a. The liquid recovery unit 64 has a tank that stores the recovered liquid L, and a suction unit that sucks the liquid L.

The supply nozzle 62a and the recovery nozzle 64a are arranged on the circumference so as to enclose the contour of the final lens 32 of the projection optical system 30. The supply nozzle 62a is arranged inside the recovery nozzle 64a.

Nozzle ports of the supply nozzle 62a and the recovery nozzle 64a are porous so as to prevent positional scattering of the supply amount and the recovery amount of the liquid L and dripping of the liquid L. As discussed above, metal can elute from the liquid contacting part that contacts the liquid L (such as the supply nozzle 62a, the recovery nozzle 64a, and the liquid holding plate 50) in the liquid L. Metal that elutes in the liquid L can adhere to the surface of the wafer 40, scatter in the liquid, and negatively affect the electric characteristic of the semiconductor device, etc. Thus, preferably, the supply nozzle 62a, the recovery nozzle 64a, and the liquid holding plate 50 are made of porous ceramic that contains Si (such as SiC Si₃N₄) or Al₂O₃ in its composition. Nevertheless, particles, such as metal, can elute in the liquid L from porous ceramic.

Accordingly, this embodiment makes at least one of the supply nozzle 62a, the recovery nozzle 64a, and the liquid holding plate 50 of porous ceramic having an oxide film. More specifically, the liquid contacting part that contacts the liquid L and the liquid passing part through which the liquid L (such as the supply port of the supply nozzle 62a, the recovery port of the recovery nozzle 64a, the recovery port of the liquid holding plate 50) passes are made of porous ceramic having the oxide film in at least one of the supply nozzle 62a, the recovery nozzle 64a, and the liquid holding plate 50. The oxide film absorbs the impurities that have adhered to the porous ceramic surface, and prevents metal from the impurities and the porous ceramic from eluting in the liquid L. Therefore, the particles, such as impurities and metal, which would contain in the liquid L can be reduced. The oxide film is formed on the porous ceramic surface or surface layer through the heat treatment or the film formation.

Preferably, the oxide film has a thickness between 10 μm and 500 μm. The oxide film thinner than 10 μm (due to the short heat treatment time period and film formation time period) quickly absorbs a small amount of impurities that have adhered to the porous ceramic surface, etc. As a result, the impurities can elute in the liquid L. On the other hand, the oxide film thicker than 500 μm result in excessively small porous ceramic particles (in particular, when it is made through the heat treatment). As a result, the metal or particles can elute in the liquid L. The oxide film formed on the porous ceramic surface preferably uses SiO₂, SiCO, AlO, and another oxide film.

This inventor makes the supply nozzle 62a, the recovery nozzle 64a, and the liquid holding plate 50 of a material that contains porous ceramic having the oxide film, and evaluates the particle amount eluting the liquid L.

### First Embodiment

The first embodiment uses ultra-pure water for the liquid L, and a silicon wafer for the wafer 40. In addition, this embodiment uses heat-treated porous SiC that has an oxide film (SiO₂ film) on its surface for porous ceramic for the supply nozzle 62a and the recovery nozzle 64a.

The particles have already adhered to or can be generated from the pipe that supplies and recovers the liquid L. Accordingly, the recovery nozzle 62a and recovery nozzle 64a are attached, only after ultra-pure water is sufficiently flowed through them so as to confirm that a particle amount is zero. The particle amount in the ultra-pure water obtained through the nozzle port of the supply nozzle 62a is evaluated using a particle counter. In order to compare the evaluation of the particle amount, the supply nozzle 62a and the recovery nozzle 64a are made of the non-heat-treated porous SiC that has no oxide film (SiO₂ film) on its surface, and the particle amount from the supply nozzle 62a is evaluated.

Table 1 compares the particle amount between the supply nozzle 62a made of heat-treated porous SiC having an oxide film (SiO₂ film) and the supply nozzle made of non-heat-treated porous SiC that has no oxide film (SiO₂ film). In Table 1, the particle amount of the supply nozzle made of the non-heat-treated porous SiC that has no oxide film (SiO₂ film) is set to 100, and other amounts are relative amounts to it:

TABLE 1

| | PARTICLE |
|---|---|
| SAMPLE | AMOUNT |
| NON-HEAT-TREATED POROUS SIC | 100 |
| (WITH NO SiO₂ FILM) | |
| HEAT-TREATED POROUS SIC (WITH SiO₂ FILM) \textcircled{1} | 0.13 |
| HEAT-TREATED POROUS SIC (WITH SiO₂ FILM) \textcircled{2} | 0.04 |
| HEAT-TREATED POROUS SIC (WITH SiO₂ FILM) \textcircled{3} | 0.12 |

It is understood from Table 1 that the heat treatment to porous SiC would make the particle amount from the supply nozzle 62a one-thousandth or below as large as that of non-heat-treated porous SiC.

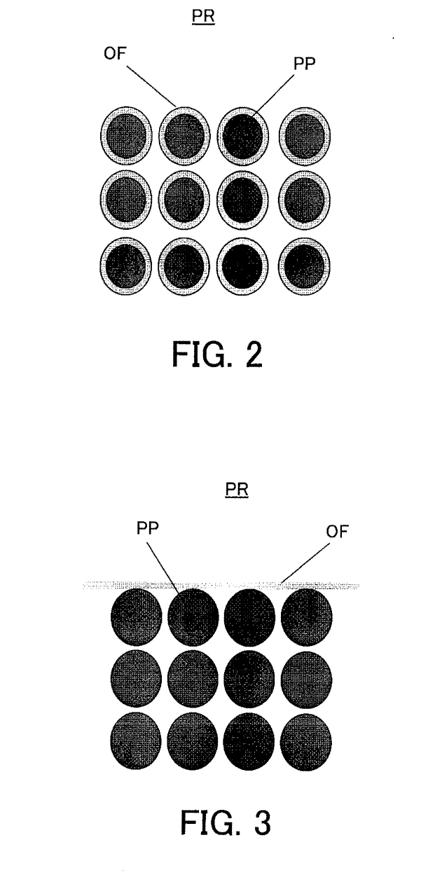

FIG. 2 is a schematic sectional view of heat-treated porous SiC PR. Heat-treated porous SiC PR forms an oxide film OF (which is a SiO₂ film in the first embodiment) on each of its SiC particles PP, as shown in FIG. 2. The oxide film (SiO₂ film) OF strengthens bonds among SiC particles PP, and restrains the particles from the porous SiC PR.

The first embodiment uses SiC for porous SiC, and SiO₂ for the oxide film. However, a similar effect is available with a material other than SiC, such as a compound that contains a composition of Si, e.g., Si₃N₄, a compound that does not contain Si, e.g., Al₂O₃. Also, the oxide may use SiCO and AlO.

### Second Embodiment

Similar to the first embodiment, the second embodiment uses ultra-pure water for the liquid L, and a silicon wafer for the wafer 40. In addition, this embodiment uses porous SiC that has a surface layer on which an oxide film (which is a SiO₂ film in this embodiment) is formed through vacuum evaporation and sputtering, for porous ceramic for the supply nozzle 62a and the recovery nozzle 64a.

The particles have already adhered to or can be generated from the pipe that supplies and recovers the liquid L. Accordingly, the recovery nozzle 62a and recovery nozzle 64a are attached, only after the ultra-pure water is sufficiently flowed through them so as to confirm that the particle amount is zero. The particle amount in the ultra-pure water obtained through the nozzle port of the supply nozzle 62a is evaluated using a particle counter. In order to compare the evaluation of the particle amount, the supply nozzle 62a and the recovery nozzle 64a are made of the non-film formation porous SiC that has no oxide film (SiO₂ film) on its surface, and the particle amount from the supply nozzle 62a is evaluated.

Similar to the first embodiment, porous SiC having the oxide film (SiO₂ film) formed on its surface layer results in a smaller particle amount than that of porous SiC having no oxide film (SiO₂ film) on its surface layer.

FIG. 3 is a schematic sectional view of porous SiC PR having an oxide film (SiO₂ film) OF on its surface layer. As shown in FIG. 3, the oxide film (SiO₂ film) OF formed on the surface layer of the porous SiC strengthens the porous SiC surface layer, providing a similar effect to that of the heat treatment, although heat-treated porous SiC has an oxide film (SiO₂ film) OF on each of SiC particles PP, and provide a larger effect than porous SiC that forms the oxide film (SiO₂ film) only on the surface layer. A much larger effect is available when the heat treatment is combined with the film formation.

The second embodiment uses SiC for porous SiC, and SiO₂ for the oxide film. However, a similar effect is available with a material other than SiC, such as a compound that contains a composition of Si, e.g., Si₃N₄, a compound that does not contain Si, e.g., Al₂O₃. Also, the oxide may use SiCO and AlO.

### Third Embodiment

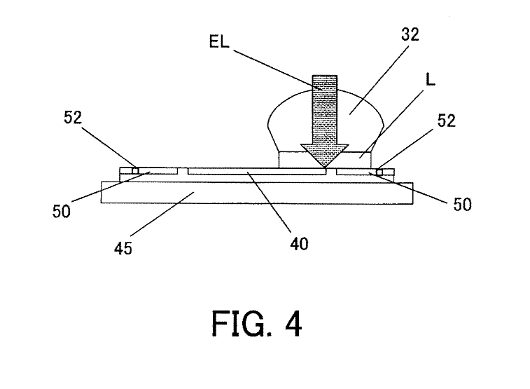

FIG. 4 is a schematic sectional view around the final lens 32 of the projection optical system 30 in exposing the edge or peripheral area on the wafer 40. In exposing the edge areas of the wafer 40, the exposure light EL is irradiated onto the liquid holding plate 50 that holds the liquid L with the wafer 40. In that case, the particles can newly occur due to the extrinsic factor, such as the heat by the exposure light EL.

The third embodiment uses ultra-pure water for the liquid L, and a silicon wafer for the wafer 40. In addition, this embodiment uses heat-treated porous SiC that has an oxide film (SiO₂ film) on its surface for porous ceramic for the supply nozzle 62a and the recovery nozzle 64a. Heat-treated porous SiC that has an oxide film (SiO₂ film) on its surface is also used for porous ceramic for the liquid holding layer 50.

The particles have already adhered to or can be generated from the pipe that supplies and recovers the liquid L. Accordingly, the recovery nozzle 62a, the recovery nozzle 64a, and the liquid holding plate 50 are attached, only after the ultra-pure water is sufficiently flowed through them so as to confirm that the particle amount is zero. The particle amount in the ultra-pure water obtained through the exposure to the edge areas of the wafer 40 (while the exposure light EL is irradiated onto the liquid holding plate 50) is evaluated using a particle counter. In order to compare the evaluation of the particle amount, the supply nozzle 62a and the recovery nozzle 64a are made of non-heat-treated porous SiC that has no oxide film (SiO₂ film) on its surface, and the liquid holding plate 50 is mada of non-heat-treated porous SiC that has no oxide film (SiO₂ film) on its surface and the particle amount from the liquid holding plate 50 is evaluated.

Table 2 compares the particle amount between the liquid holding plate 50 made of the heat-treated porous SiC having an oxide film (SiO₂ film) and the liquid holding plate 50 made of non-heat-treated porous SiC that has no oxide film (SiO₂ film). In Table 2, the particle amount of non-heat-treated porous SiC that has no oxide film (SiO₂ film) is set to 100, and another amount is a relative amount to it:

TABLE 2

| | PARTICLE |
|---|---|
| SAMPLE | AMOUNT |
| NON-HEAT-TREATED POROUS SIC | 100 |
| (WITH NO SiO₂ FILM) | |
| HEAT-TREATED POROUS SIC (WITH SiO₂ FILM) | 0.09 |

It is understood from Table 2 similar to the first embodiment that the heat treatment would make the particle amount from the liquid holding plate 50 for the exposure to the edge (or which receives the exposure light EL) ten-thousandth or below. As shown in FIG. 2, the heat treatment forms an oxide film (which is an SiO₂ film in the third embodiment) on each SiC particle, and the oxide film (SiO₂ film) strengthens bonds among the SiC particles, restraining the particles from the porous SiC.

The liquid holding plate 50 made of porous SiC having an oxide film (SiO₂ film) on its surface layer is also evaluated, and the evaluation consequently reveals that the liquid holding plate 50 made of porous SiC having an oxide film (SiO₂ film) on its surface layer reduces the particles. This is because, as shown in FIG. 3, the oxide film (SiO₂ film) formed on the surface layer of the porous SiC strengthens the porous SiC surface layer, providing a similar effect to that of the heat treatment. A much larger effect is available when the heat treatment is combined with the film formation.

The third embodiment uses SiC for porous SiC, and SiO₂ for the oxide film. However, a similar effect is available with a material other than SiC, such as a compound that contains a composition of Si, e.g., Si₃N₄, a compound that does not contain Si, e.g., Al₂O₃. Also, the oxide may use SiCO and Al.

### Fourth Embodiment

The oxide film formed on the porous ceramic surface through the heat treatment has an elution restraining effect of the impurities, such as metal, in the liquid L, as well as restraining the particles.

The fourth embodiment uses heat-treated porous SiC having an oxide film (SiO₂ film) on its surface for porous SiC, and pure water for the liquid L. This embodiment fills porous SiC in the ultra-pure water (liquid L), and measures eluted metal ions. As a comparative example, non-heat-treated porous SiC having no oxide film (SiO₂ film) on its surface is similarly evaluated. It is confirmed that no metal ions exist in the ultra-pure water (liquid L) in which porous SiC is put.

Table 3 compares the metal elution amount from heat-treated porous SiC having the oxide film (SiO₂ film) with that from non-heat-treated porous SiC having no oxide film (SiO₂ film). In Table 3, an Al elution amount from non-heat-treated porous SiC is set to 100. Zn and Ba elution amounts from non-heat-treated porous SiC and Al, Zn, and Ba elution amounts from heat-treated porous SiC are relative amounts to the Al elution amount from non-heat-treated porous SiC.

TABLE 3

| SAMPLE | METAL ELUTION AMOUNT |
|---|---|
| NON-HEAT-TREATED | Al: 100, Zn: 15, Ba: 11 |
| POROUS SiC | |
| HEAT-TREATED POROUS SiC | Al: 0.09, Zn: 0, Ba: 0 |
| | (BELOW DETECTION LIMITS) |

Referring to Table 3, metal ions elute from non-heat-treated porous SiC in the ppm level to the ppb level. On the other hand, it is understood that the elution amount of metal ions from heat-treated porous SiC is maintained below the detection limits. This is because the heat treatment concentrates or absorbs the oxide film (SiO₂ film) and restrains, as shown in FIG. 2, the impurities in porous SiC, such as metal, from eluting in the ultra-pure water (liquid L).

The fourth embodiment uses SiC for porous SiC, and SiO₂ for the oxide film. However, a similar effect is available with a material other than SiC, such as a compound that contains a composition of Si, e.g., Si₃N₄, a compound that does not contain Si, e.g., Al₂O₃. Also, the oxide may use SiCO and AlO.

Thus, the exposure apparatus 1 makes the liquid contacting part that contacts the liquid L and the liquid passing part through which the liquid L passes of porous ceramic having an oxide film, preventing inclusions of the particles into the liquid L.

In exposure, the light is emitted from the light source 12 illuminated the reticle 20 via the illumination optical system 14. The light that passes through the reticle 20 and reflects the reticle pattern is imaged onto the wafer 40 by the projection optical system 30 via the liquid L. The liquid L of the exposure apparatus 1 has or generates a restrained amount of particles that affect the optical characteristic, preventing disconnections of the wiring structure and the partially low contrast. Therefore, the exposure apparatus 1 can provide high-quality devices, such as semiconductor devices and LCD devices, with high throughput and economic efficiency.

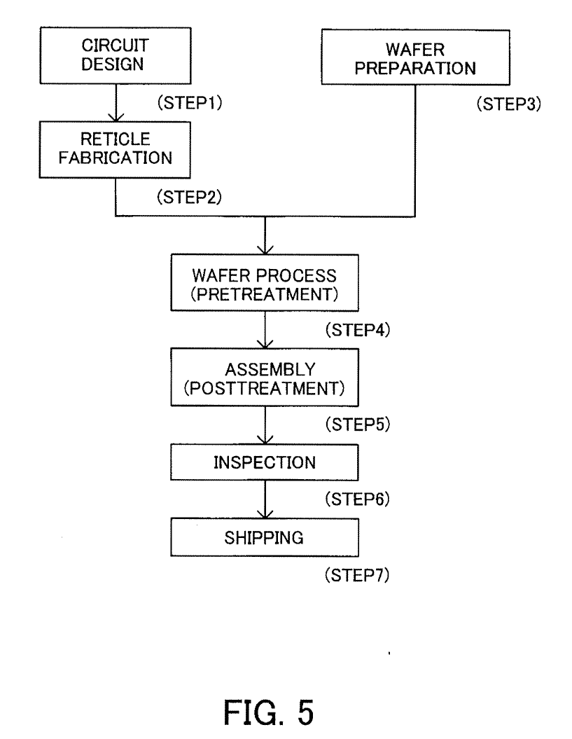

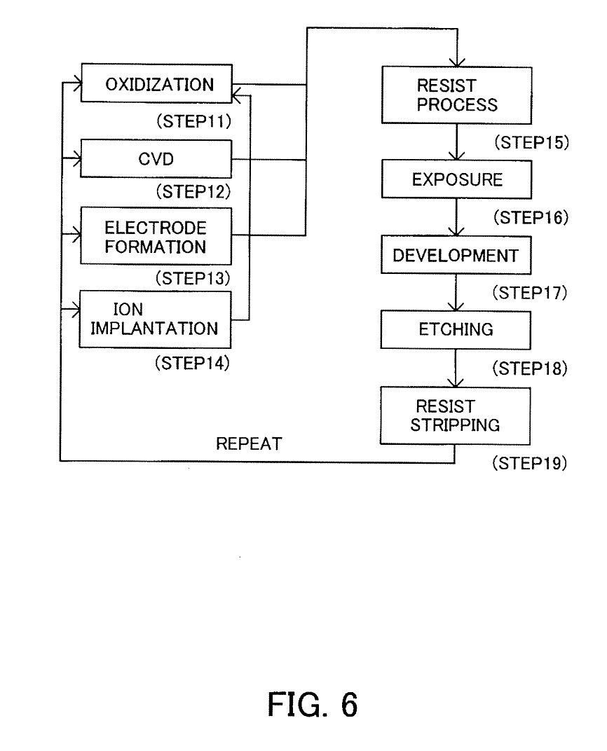

Referring now to FIGS. 5 and 6, a description will be given of an embodiment of a device manufacturing method using the exposure apparatus 1. FIG. 5 is a flowchart for explaining how to fabricate devices, such as a semiconductor device and a LCD device. Here, a description will be given of the fabrication of a semiconductor device as an example. Step 1 (circuit design) designs a semiconductor device circuit. Step 2 (reticle fabrication) forms a reticle having a designed circuit pattern. Step 3 (wafer preparation) manufactures a wafer using materials such as silicon. Step 4 (wafer process), which is also referred to as a pretreatment, forms the actual circuitry on the wafer through lithography using the mask and wafer. Step 5 (assembly), which is also referred to as a post-treatment forms into a semiconductor chip the wafer formed in Step 4 and includes an assembly step (e.g., dicing, bonding), a packaging step (chip sealing), and the like. Step 6 (inspection) performs various tests on the semiconductor device made in Step 5, such as a validity test and a durability test. Through these steps, a semiconductor device is finished and shipped (Step 7).

FIG. 6 is a detailed flowchart of the wafer process in Step 4. Step 11 (oxidation) oxidizes the wafer's surface. Step 12 (CVD) forms an insulating layer on the wafer's surface. Step 13 (electrode formation) forms electrodes on the wafer by vapor disposition and the like. Step 14 (ion implantation) implants ions into the wafer. Step 15 (resist process) applies a photosensitive material onto the wafer. Step 16 (exposure) uses the exposure apparatus 1 to expose a circuit pattern of the reticle onto the wafer. Step 17 (development) develops the exposed wafer. Step 18 (etching) etches parts other than a developed resist image. Step 19 (resist stripping) removes unused resist after etching. These steps are repeated to form multi-layer circuit patterns on the wafer. The device manufacturing method of this embodiment may manufacture higher quality devices than ever. Thus, the device manufacturing method using the exposure apparatus 1, and resultant devices constitute one aspect of the present invention.

Further, the present invention is not limited to these preferred embodiments and various variations and modifications may be made without departing from the scope of the present invention. For example, when the exposure apparatus forms an air curtain, supply/recovery nozzles for supplying and recovering the gas for forming the air curtain may be made of porous ceramic having an oxide film.

This application claims a foreign priority benefit based on Japanese Patent Application No. 2006-019134, filed on Jan. 27, 2006, which is hereby incorporated by reference herein in its entirety as if fully set forth herein.

What is claimed:

1. An exposure apparatus for exposing a substrate via liquid, the exposure apparatus comprising:
a supply nozzle configured to supply the liquid; and
a recovery nozzle configured to recover the liquid, wherein at least one of the supply nozzle and the recovery nozzle includes porous ceramic with an oxide film.

2. An exposure apparatus according to claim 1, wherein a supply port of the supply nozzle or a recovery port of the recovery nozzle is made of porous ceramic with the oxide film.

3. An exposure apparatus according to claim 1, wherein the oxide film is made through a heat treatment or a film formation.

4. An exposure apparatus according to claim 1, wherein porous ceramic arranges the oxide film on a surface of a particle.

5. An exposure apparatus according to claim 1, wherein the oxide film has a thickness between 10 μm and 500 μm.

6. An exposure apparatus according to claim 1, wherein ceramic porous is made of Si or Al₂O₃.

7. An exposure apparatus according to claim 1, wherein the oxide film is made of SiO₂, SiCO or AlO.

8. An exposure apparatus for exposing a substrate via liquid, the exposure apparatus comprising a liquid holding plate configured to hold the liquid, the liquid holding plate being arranged around the substrate, and including porous ceramic with an oxide film.

9. An exposure apparatus according to claim 8, wherein the liquid holding plate has a recovery port configured to recover the liquid, the recovery port including porous ceramic with an oxide film.

10. A device manufacturing method comprising:
exposing a substrate using an exposure apparatus; and
developing the substrate that has been exposed,
wherein the exposure apparatus includes:
a supply nozzle configured to supply the liquid; and
a recovery nozzle configured to recover the liquid, wherein at least one of the supply nozzle and the recovery nozzle includes porous ceramic with an oxide film.
